(19) United States
(12) Patent Application Publication
(10) Pub. No.: US 2011/0093675 A1
(43) Pub. Date: Apr. 21, 2011

(54) METHOD FOR PROTECTING REDUNDANT DATA

(75) Inventors: Ying-Chih Lu, Taipei City (TW); Yu-Hui Wang, Taipei City (TW)

(73) Assignee: INVENTEC CORPORATION, Taipei City (TW)

(21) Appl. No.: 12/767,084

(22) Filed: Apr. 26, 2010

(30) Foreign Application Priority Data
Oct. 20, 2009 (TW) 98135468

(51) Int. Cl. G06F 12/16

(52) U.S. Cl. 711/162; 711/E12.103; 711/202

(57) ABSTRACT

A method for protecting redundant data is provided. In the present invention, when a working data area and a redundant data area are not destroyed, whether global unique identifiers (GUIDs) of both the working data area and the redundant data area are the same is determined when a power on self test (POST) is executed. If the GUIDs are different, the data of the working data area is synchronized to the redundant data area. Next, the working data area and the redundant data area are set to share the same memory address space. One of the working data area and the redundant data area is selected for mapping to the memory address space in case that an operating system is executed.

### CROSS-REFERENCE TO RELATED APPLICATION

This application claims the priority benefit of Taiwan application serial no. 98135468, filed on Oct. 20, 2009. The entirety of the above-mentioned patent application is hereby incorporated by reference herein and made a part of this specification.

### BACKGROUND OF THE INVENTION

1. Field of the Invention

The present invention relates to a boot method. More particularly, the present invention relates to a method for protecting redundant data.

2. Description of Related Art

Generally, when a computer system is booted, a basic input output system (BIOS) thereof is first started to execute a power on self test (POST). After the POST is completed, the BIOS integrate data related to the computer system into a table, and write the table into a main memory. The data related to the computer system is for example, information of a manufacturer, a BIOS manufacturer, a computer serial No., a universal unique identifier (UUID), etc., which is already written into a non-volatile memory (NVRAM) of a BIOS Flash ROM when the computer is fabricated. Namely, the BIOS stores extracted data into the main memory in a data structure approach according to a specification of a system management BIOS (SMBIOS). To avoid damage of the SMBIOS that causes a boot failure, a redundant data area is configured in the BIOS flash ROM to serve as a backup.

However, the redundant data area is not protected according to an existing method. When an operating system is operated, the redundant data area can still be accessed, so that the redundant data area is vulnerable to be destroyed.

### SUMMARY OF THE INVENTION

The present invention is directed to a method for protecting redundant data, by which a redundant data area can be hidden while an operating system is executed.

The present invention provides a method for protecting redundant data, which is adapted to a firmware memory including a working data area and a redundant data area. In the present method, if data in the working data area and the redundant data area are not destroyed, whether a first global unique identifier (GUID) of the working data area is the same to a second GUID of the redundant data area is determined when a power on self test (POST) is executed. If the first GUID is different to the second GUID, the data of the working data area is synchronized to the redundant data area. Next, the working data area and the redundant data area are set to share a same memory address space. Next, one of the working data area and the redundant data area is selected for mapping to the memory address space according to an area switch register in case that an operating system is executed. For example, when the area switch register records a first predetermined value, the redundant data area is skipped and the working data area is selected for mapping to the memory address space in case that the operating system is executed. On the other hand, when the area switch register records a second predetermined value, the working data area is skipped and the redundant data area is selected for mapping to the memory address space in case that the operating system is executed.

In an embodiment of the present invention, the method for protecting the redundant data further includes setting a working substrate register, a redundant substrate register, an area size register and an area switch register in a chip. The working substrate register and the redundant substrate register respectively record offset addresses of the working data area and the redundant data area in the firmware memory. The area size register records sizes of the working data area and the redundant data area. The area switch register records the first predetermined value or the second predetermined value.

In an embodiment of the present invention, before the step of determining whether the first GUID is the same to the second GUID, a first signature and a second signature are set by a basic input output system (BIOS), wherein the first signature and the second signature are respectively recorded in the working data area and the redundant data area. Then, whether the working data area and the redundant data area are destroyed is determined according to the first signature and a first checksum recorded in the working data area and the second signature and a second checksum recorded in the redundant data area.

In an embodiment of the present invention, steps of determining whether the working data area and the redundant data area are destroyed are described in detail as follows. Whether the working data area is destroyed is determined according to the first signature and the first checksum recorded in the working data area. If the working data area is destroyed, whether the redundant data area is destroyed is determined according to the second signature and the second checksum recorded in the redundant data area. Conversely, if the working data area is not destroyed, whether the redundant data area is destroyed is also determined. If the working data area and the redundant data area are all not destroyed, whether the first GUID of the working data area is the same to the second GUID of the redundant data area is determined, and if the first GUID is different to the second GUID, the data of the working data area is synchronized to the redundant data area. If the working data area is not destroyed and the redundant data area is destroyed, the data of the working data area is directly synchronized to the redundant data area. The step of synchronizing the data of the working data area to the redundant data area includes writing the data and the second signature set by the BIOS of the working data area into the redundant data area, and recalculating the second checksum.

Moreover, if the working data area is destroyed and the redundant data area is not destroyed, the data and the first signature set by the BIOS in the redundant data area are written into the working data area, and the first checksum is recalculated. In addition, if the data in the working data area and the redundant data area are all destroyed, a message is prompted.

According to the above descriptions, in the present invention, during a mapping process, the working data area and the redundant data area can share the same memory address space, and when the operating system is operated, the memory address space is assigned to the working data area for utilization. By such means, modification of the redundant data area can be avoided. Moreover, when the operating system modifies the data of the working data area, the operating system also provides a new GUID, and writes the new GUID into a GUID column of a header of the working data area.

In order to make the aforementioned and other features and advantages of the present invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating a method for protecting redundant data according to an embodiment of the present invention.

FIG. 2 is a diagram illustrating a relationship between a memory address space and a firmware memory according to an embodiment of the present invention.

FIG. 3 is flowchart illustrating a method for protecting redundant data according to another embodiment of the present invention.

### DESCRIPTION OF THE EMBODIMENTS

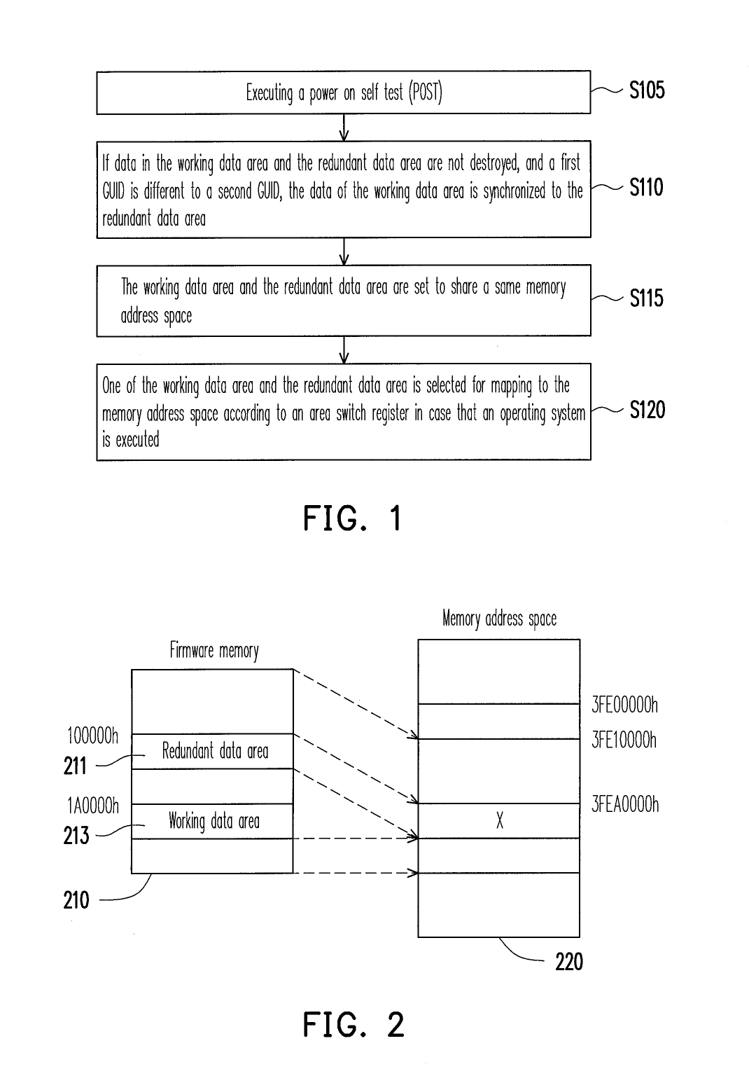

FIG. 1 is a flowchart illustrating a method for protecting redundant data according to an embodiment of the present invention. This method is adapted to a firmware memory, for example, a flash read-only memory used for storing a basic input output system (BIOS). In the present embodiment, the firmware memory includes a working data area and a redundant data area. The redundant data area serves as a backup of the working data area.

Referring to FIG. 1, first, in step S105, the BIOS executes a power on self test (POST). Here, the BIOS first initialize a system memory, so that the system memory can be accessed. Moreover, the BIOS maps the firmware memory to a memory address space below a 4G-1 address.

Next, in step S110, if data in the working data area and the redundant data area are not destroyed, and a global unique identifier (GUID) of the working data area is detected to be different to a GUID of the redundant data area, the data of the working data area is synchronized (written) to the redundant data area. Such step is intended to always maintain a consistency of the data in the working data area and the redundant data area.

Next, in step S115, the working data area and the redundant data area are set to share a same memory address space. Moreover, in step S120, one of the working data area and the redundant data area is selected for mapping to the memory address space according to an area switch register in case that an operating system is executed. Namely, when the area switch register records a first predetermined value (for example, 0), the redundant data area is skipped and the working data area is selected for mapping to the memory address space in case that the operating system is executed. On the other hand, when the area switch register records a second predetermined value (for example, 1), the working data area is skipped and the redundant data area is selected for mapping to the memory address space in case that the operating system is executed. By such means, the working data area and the redundant data area can share the same memory address space, and in case that the operating system is executed, one of the two areas can be hidden, and only another one of the two areas is accessed.

To protect the redundant data area from arbitrary modification, the value of the area switch register is set to 0, so that when the operating system is executed, the redundant data area is hidden.

To be specific, registers in a chip (for example, a south bridge chip) can be set to accomplish the above steps. The registers include a working substrate register, a redundant substrate register, an area size register and an area switch register. The working substrate register and the redundant substrate register respectively record offset addresses of the working data area and the redundant data area in the firmware memory. The area size register records sizes of the working data area and the redundant data area. The area switch register records the first predetermined value or the second predetermined value, which is used for determining whether the working data area or the redundant data area is selected for mapping to the memory address space.

For example, FIG. 2 is a diagram illustrating a relationship between the memory address space and the firmware memory according to an embodiment of the present invention. Here, assuming the working substrate register is 1A0000h, the redundant substrate register is 100000h, and the area size register is 10000h (64K).

Referring to FIG. 2, each address in the firmware memory 210 corresponds to an address in the memory address space 220, so that a processor can access the data in the firmware memory 210 according to the addresses defined in the memory address space 220. Here, the firmware memory 210 includes a redundant data area 211 and a working data area 213. Wherein, a start position of the redundant data area 211 in the firmware memory 210 is 100000h, and a size thereof is 64K. A start position of the working data area 213 in the firmware memory 210 is 1A0000h, and a size thereof is 64K. Since the redundant data area 211 and the working data area 213 shares a memory address space X, compared to a conventional method, a memory address space of 64K is saved.

Moreover, a format of each of the working data area 213 and the redundant data area 211 includes two parts of a header and a body. The body is used for storing data (for example, a system management BIOS (SMBIOS) data), and the header is used for recording a signature, the GUID and a checksum. The GUID is used for identifying whether the data of the working data area 213 is consistent to the data of the redundant data area 211. The signature and the checksum are used for determining whether the data in the wording data area 213 and the redundant data area 211 are valid or destroyed. Another embodiment is provided below for detailed description.

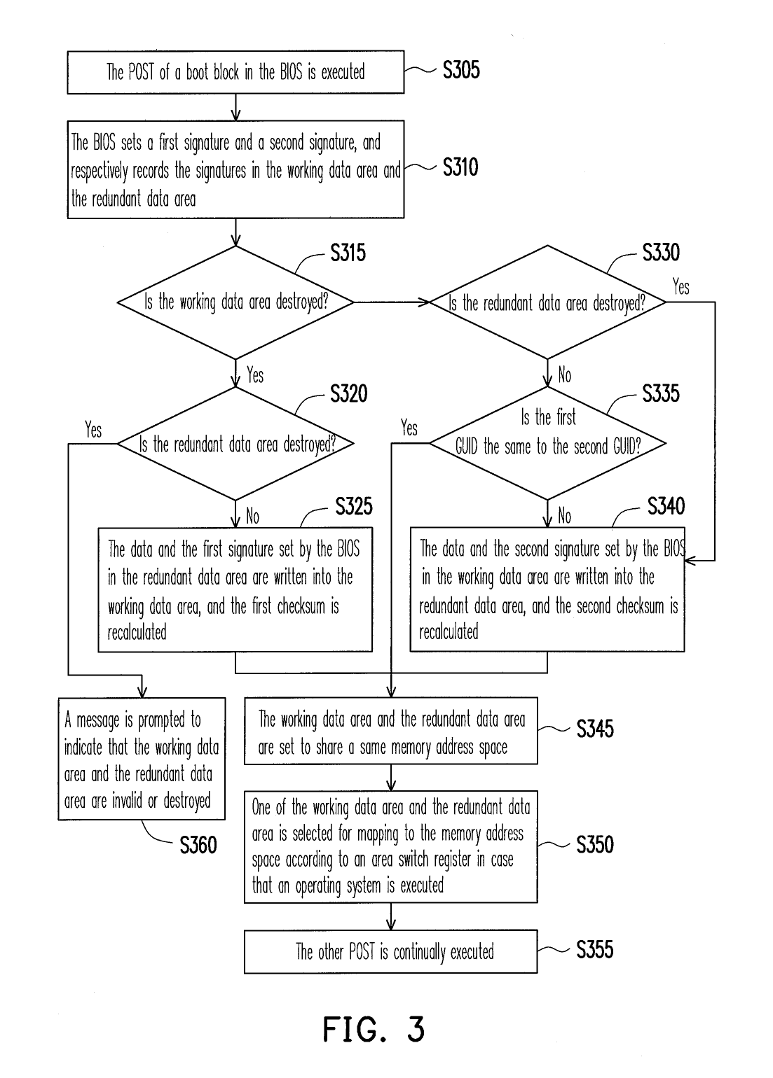

FIG. 3 is flowchart illustrating a method for protecting redundant data according to another embodiment of the present invention. Referring to FIG. 3, in step S305, the POST of a boot block in the BIOS is executed to initialise a system memory for accessing. Moreover, the firmware memory is mapped to a memory address space below the 4G-1 address.

Next, in step S310, a first signature and a second signature are set by the BIOS, wherein the first signature and the second signature are respectively recorded in the working data area and the redundant data area. Then, whether the working data area and the redundant data area are destroyed is determined according to the first signature and a first checksum recorded in the working data area and the second signature and a second checksum recorded in the redundant data area.

In step S315, whether the working data area is destroyed is determined according to the first signature and the first checksum recorded in the working data area. If the working data area is destroyed, a step S320 is executed, by which whether the redundant data area is destroyed is determined according to the second signature and the second checksum recorded in the redundant data area. If the redundant data area is not destroyed, in step S325, the data and the first signature set by the BIOS in the redundant data area are written into the working data area, and the first checksum is recalculated.

Back to the step S315, if the working data area is not destroyed, a step S330 is executed, by which whether the redundant data area is destroyed is determined according to the second signature and the second checksum recorded in the redundant data area.

If the working data area and the redundant data area are all not destroyed, a step S335 is executed to determine whether the data in the working data area and the redundant data area are synchronous. Namely, whether the first GUID of the working data area is the same to the second GUID of the redundant data area is determined. If the first GUID is different to the second GUID, in step S340, the data of the working data area is synchronized to the redundant data area.

In the step S340, the data and the second signature set by the BIOS in the working data area are written into the redundant data area, and the second checksum is recalculated. Now, the data of the redundant data area is the same to the data of the working data area.

Next, steps S345 and S350 are respectively the same or similar to the aforementioned steps S115 and S120, and therefore detailed descriptions thereof are not repeated. Finally, in step S355, other POSTs (for example, the POST in a main block) are continually executed.

It should be noticed that if the working data area and the redundant data area are all destroyed, a step S360 is executed, by which a message is prompted to indicate that the working data area and the redundant data area are invalid or destroyed.

In summary, during a mapping process, the working data area and the redundant data area can share the same memory address space, and when the operating system is operated, the memory address space is assigned to the working data area for utilization. Moreover, the data in the redundant data area and the data in the working data area are maintained consistent according to the aforementioned method, and an operation of maintaining a consistency of the data in the working data area and the redundant data area can be completed during the POST process. In addition, since the redundant data area is not mapped to the memory address space when the operating system is executed, the redundant data area cannot be accessed in case that the operating system is executed. By such means, the redundant data area is protected from a malicious or intentional damage. Moreover, when the operating system modifies the data of the working data area, the operating system also provides a new GUID, and writes the new GUID into a GUID column of the header of the working data area.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for protecting redundant data, adapted to a firmware memory comprising a working data area and a redundant data area, the method for protecting redundant data comprising:
determining whether a first global unique identifier (GUID) of the working data area is the same to a second GUID of the redundant data area if data in the working data area and the redundant data area are not destroyed when a power on self test (POST) is executed;
synchronizing the data of the working data area to the redundant data area if the first GUID is different to the second GUID;
setting the working data area and the redundant data area to share a memory address space; and
selecting one of the working data area and the redundant data area for mapping to the memory address space according to an area switch register in case that an operating system is executed, which comprising:
skipping the redundant data area and selecting the working data area for mapping to the memory address space when the area switch register records a first predetermined value in case that the operating system is executed; and
skipping the working data area and selecting the redundant data area for mapping to the memory address space when the area switch register records a second predetermined value in case that the operating system is executed.

2. The method for protecting the redundant data as claimed in claim 1, further comprising:
setting a working substrate register, a redundant substrate register, an area size register and an area switch register in a chip, wherein the working substrate register and the redundant substrate register respectively record offset addresses of the working data area and the redundant data area in the firmware memory, the area size register records sizes of the working data area and the redundant data area, and the area switch register records the first predetermined value or the second predetermined value.

3. The method for protecting the redundant data as claimed in claim 1, wherein before the step of determining whether the first GUID is the same to the second GUID, the method further comprises:
setting a first signature and a second signature by a basic input output system (BIOS), wherein the first signature and the second signature are respectively recorded in the working data area and the redundant data area; and
determining whether the working data area and the redundant data area are destroyed according to the first signature and a first checksum recorded in the working data area and the second signature and a second checksum recorded in the redundant data area.

4. The method for protecting the redundant data as claimed in claim 3, wherein the step of determining whether the working data area and the redundant data area are destroyed comprises:
determining whether the working data area is destroyed according to the first signature and the first checksum recorded in the working data area;
determining whether the redundant data area is destroyed according to the second signature and the second checksum recorded in the redundant data area if the working data area is destroyed;
writing the data and the first signature set by the BIOS of the redundant data area into the working data area, and recalculating the first checksum if the redundant data area is not destroyed.

5. The method for protecting the redundant data as claimed in claim 4, wherein after the step of determining whether the working data area is destroyed according to the first signature and the first checksum recorded in the working data area, the method further comprises:
determining whether the redundant data area is destroyed according to the second signature and the second checksum recorded in the redundant data area if the working data area is not destroyed; and
determining whether the first GUID of the working data area is the same to the second GUID of the redundant data area if the redundant data area is not destroyed, and synchronizing the data of the working data area to the redundant data area if the first GUID is different to the second GUID.

6. The method for protecting the redundant data as claimed in claim 5, wherein if the working data area is not destroyed and the redundant data area is destroyed, the data of the working data area is synchronized to the redundant data area.

7. The method for protecting the redundant data as claimed in claim 5, wherein the step of synchronizing the data of the working data area to the redundant data area comprises:
writing the data and the second signature set by the BIOS of the working data area into the redundant data area, and recalculating the second checksum.

8. The method for protecting the redundant data as claimed in claim 1, further comprising:
prompting a message when the data in the working data area and the redundant data area are all destroyed.
